(19) United States
(12) Patent Application Publication
(10) Pub. No.: US 2009/0076548 A1
(43) Pub. Date: Mar. 19, 2009

(54) Teething fingers

(76) Inventor: Jane Letsche, Palm Beach, FL (US)

Correspondence Address: JAMES RAY & ASSOCIATES, 2640 PITCAIRN ROAD, MONROEVILLE, PA, 15146, US

(21) Appl. No.: 11/901,833

(22) Filed: Sep. 19, 2007

(51) Int. Cl. A61J 17/02

(52) U.S. Cl. 606/235

(57) ABSTRACT

A teething device for use by an infant. The teething device has a base manufactured from a first predetermined material and the base has a first predetermined size and a first predetermined shape. There is at least one projection protruding from a first predetermined side of the base such that the at least one projection will fit in an infant's mouth. The at least one projection is manufactured from a second predetermined material and has a second predetermined size and a second predetermined shape. A handle member manufactured from a third predetermined material and has a third predetermined size and a third predetermined shape and the handle member protrudes from a second predetermined side of the base.

### FIELD OF THE INVENTION

The present invention relates, in general, to teething devices and, more particularly, this invention relates to teething devices and pacifiers.

### BACKGROUND OF THE INVENTION

Prior to the conception and development of the present invention, teething devices and pacifiers as are generally well known in the prior art, have been used to comfort babies having pain due to teething.

Specifically of interest to the present invention are the following: Chase, et al, U.S. Pat. No. 4,334,382, discloses an infant development toy comprising a plurality of rings of varying diameter connected to each other and to a central object by a flexible connecting means. The rings and central object are of a size, and are spaced along the connecting means in such a manner that, when the toy is held aloft by and suspended from the point of connection of the largest ring and the connecting means, the rings are concentric and surround the central object.

Chase, et al, U.S. Pat. No. 4,249,333, discloses an infant development toy comprising a plurality of rings of varying diameter connected to each other and to a central object by a flexible connecting means. The rings and central object are of a size, and are spaced along the connecting means in such a manner that, when the toy is held aloft by and suspended from the point of connection of the largest ring and the connecting means, the rings are concentric and surround the central object.

### SUMMARY OF THE INVENTION

The present invention provides a teething device for use by an infant. This teething device comprises a base manufactured from a first predetermined material and having a first predetermined size and a first predetermined shape. At least one projection protruding from a first predetermined side of the base such that the at least one projection will fit in an infant's mouth. The at least one projection being manufactured from a second predetermined material and having a second predetermined size and a second predetermined shape. A handle member is manufactured from a third predetermined material and having a third predetermined size and a third predetermined shape and such handle member is protruding from a second predetermined side of the base.

### OBJECTS OF THE INVENTION

It is, therefore, one of the primary objects of the present invention to provide a teething device that will have at least two infant sized finger-like projections that can fit in an infant's mouth and provide relief from teething pain.

Another object of the present invention is to provide a device similar in size and shape to an infant's fingers for an infant to chew on and alleviate pain associated with teething and that can be placed in a refrigerator or freezer to chill so that when the infant chews on the device the infant's gums will become numb.

Still another object of the present invention is to provide a teething device that is easy for an infant to hold.

Yet another object of the present invention is to provide a teething device on which on infant can chew on both sides of the infant's mouth simultaneously to provide maximum relief from teething pain.

An additional object of the present invention is to provide a teething device which, when chewed or sucked on by an infant will touch numerous surfaces of the infant's gums and teeth thereby easing teething pain.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of a teething device according to one embodiment of the invention.

FIG. 2 is a cross-sectional view taken along the lines II-II of FIG. 1.

FIG. 3 is a partial perspective view of a teething device according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

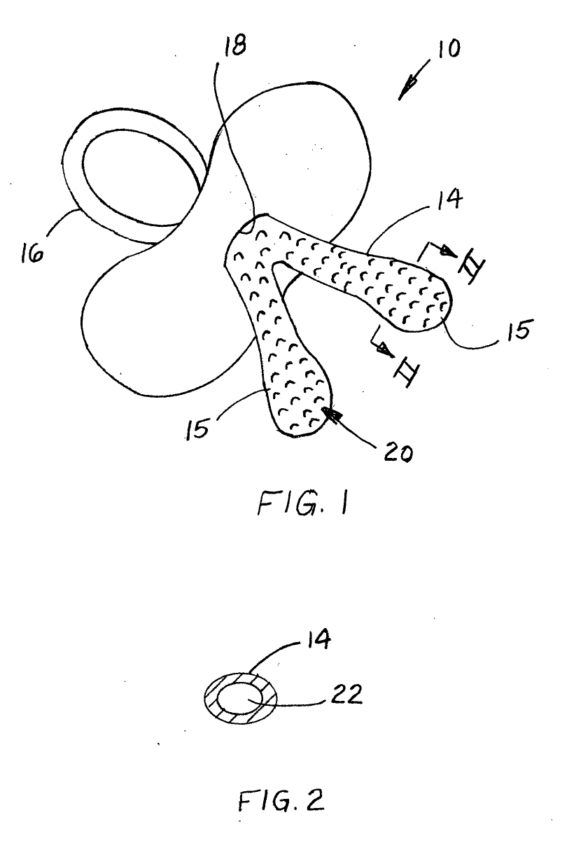

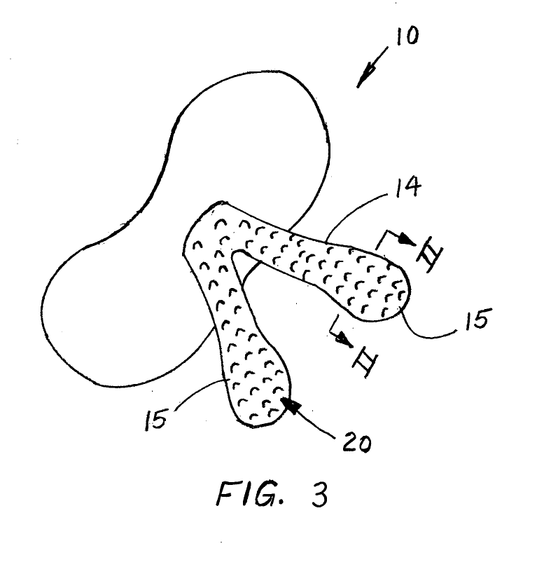

Reference is now made, more particularly, to FIGS. 1-3. According to a first embodiment of the invention, illustrated in FIGS. 1-3 is a teething device generally designated 10 for use by an infant.

The teething device 10 includes a base member 12 manufactured from a first predetermined material and of a first predetermined size and a first predetermined shape. It is presently preferred that the first predetermined material is selected from the group consisting of plastic, silicon and rubber.

At least one projection 14 protrudes from a first predetermined side of the base member 12 such that the at least one projection 14 will fit in an infant's mouth. The at least one projection 14 is manufactured from a second predetermined material and has a second predetermined size and a second predetermined shape. It is presently preferred that the second predetermined material is selected from the group consisting of silicon and rubber. It is also presently preferred that the second predetermined shape is fingerlike.

A handle member 16, manufactured from a third predetermined material and of a third predetermined size and a third predetermined shape, protrudes from a second predetermined side of the base member 12. It is presently preferred that the third predetermined material is selected from the group consisting of plastic, silicon and rubber. It is also presently preferred that the third predetermined shape is ringlike.

In the presently preferred embodiment of the invention it is preferred that the teething device 10 includes two projections 15.

According to another embodiment of the invention the two projections 15 and the handle member 16 are formed as a single piece and the second and third predetermined materials are substantially identical.

According to yet another embodiment of the invention the base member 12, the two projections 15 and the handle member 16 are formed as a single piece and the first, the second and the third predetermined material are substantially identical.

According to yet another embodiment of the invention base member 12 has an opening 18 therethrough and the handle member 16 is situated on a first predetermined side of the base member 12 and the two projections 15 are situated on a second predetermined side of the base member 12.

According to still another embodiment of the invention, the two projections 15 have at least one of a plurality of nodules and a plurality of bumps generally designated 20 along a first predetermined surface of the two projections 15. The plurality of nodules and plurality of bumps 20 are a fourth predetermined size and a fourth predetermined shape.

According to another embodiment of the invention, the at least one projection 14 has a chamber 22 filled with a gel (not shown) manufactured from a fourth predetermined material and the gel is at least one of chilled and frozen.

According to yet another embodiment of the invention, at least one of the two projections 15 has a chamber 22 filled with a gel (not shown) manufactured from a fourth predetermined material and the gel is at least one of chilled and frozen.

According to yet another embodiment of the invention, the two projections 15 are at least one of different shapes and sizes.

According to yet another embodiment of the invention, the teething device 10 includes a base member 12 manufactured from a first predetermined material and of a first predetermined size and a first predetermined shape and further includes at least one projection 14 protruding from a first predetermined side of the base member 12 such that the at least one projection 14 will fit in an infant's mouth. The at least one projection 14 is manufactured from a second predetermined material and has a second predetermined size and a second predetermined shape.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A teething device for use by an infant, said teething device comprising;
a. a base member manufactured from a first predetermined material and having a first predetermined size and a first predetermined shape;
b. at least one projection protruding from a first predetermined side of said base member such that said at least one projection will fit in an infant's mouth, said at least one projection being manufactured from a second predetermined material and having a second predetermined size and a second predetermined shape; and
c. a handle member manufactured from a third predetermined material and having a third predetermined size and a third predetermined shape protruding from a second predetermined side of said base member.

2. A teething device, according to claim 1, wherein said teething device includes two projections.

3. A teething device, according to claim 2, wherein said two projections and said handle member are formed as a single piece and said second and said third predetermined material are substantially identical.

4. A teething device, according to claim 2, wherein said base member, said two projections and said handle member are formed as a single piece and said first, said second and said third predetermined material are substantially identical.

5. A teething device according to claim 3 wherein said base member has an opening therethrough and said handle member is situated on a first predetermined side of said base member and said two projections are situated on a second predetermined side of said base member.

6. A teething device, according to claim 2, wherein said two projections have at least one of a plurality of nodules and a plurality of bumps along a first predetermined surface of said two projections, said plurality of nodules and said plurality of bumps having a fourth predetermined size and a fourth predetermined shape.

7. A teething device, according to claim 1, wherein said at least one projection has a chamber filled with a gel manufactured from a fourth predetermined material, said gel being at least one of chilled and frozen.

8. A teething device, according to claim 6, wherein at least one of said two projections has a chamber filled with a gel manufactured from a fourth predetermined material, said gel being at least one of chilled and frozen.

9. A teething device, according to claim 2, wherein said two projections are at least one of different shapes and sizes.

10. A teething device, according to claim 1, wherein said first predetermined material is selected from the group consisting of plastic, silicon and rubber.

11. A teething device according to claim 2 wherein said first predetermined material is selected from the group consisting of plastic, silicon and rubber.

12. A teething device, according to claim 1, wherein said second predetermined material is selected from the group consisting of silicon and rubber.

13. A teething device, according to claim 2 wherein said second predetermined material is selected from the group consisting of silicon and rubber.

14. A teething device for use by an infant, said teething device comprising;
a. a base member manufactured from a first predetermined material and having a first predetermined size and a first predetermined shape; and
b. at least one projection protruding from a first predetermined side of said base member such that said at least one projection will fit in an infant's mouth, said at least one projection being manufactured from a second predetermined material and having a second predetermined size and a second predetermined shape.

15. A teething device, according to claim 1, wherein said third predetermined material is selected from the group consisting of plastic, silicon and rubber.

16. A teething device, according to claim 2, wherein said third predetermined material is selected from the group consisting of plastic, silicon and rubber.

17. A teething device, according to claim 1, wherein said third predetermined shape is ringlike.

18. A teething device, according to claim 2, wherein said third predetermined shape is ringlike.

19. A teething device, according to claim 1, wherein said second predetermined shape is fingerlike.

20. A teething device, according to claim 2, wherein said second predetermined shape is fingerlike.
